(19) United States
(12) Patent Application Publication
(10) Pub. No.: US 2003/0213354 A1
(43) Pub. Date: Nov. 20, 2003

(54) Cutting tool holder with cutting tool

(76) Inventor: Gerd F. Frers, Mockmuhl (DE)

Correspondence Address: Pauley Petersen Kinne & Erickson, Suite 365, 2800 W. Higgins Road, Hoffman Estates, IL, 60195, US

(21) Appl. No.: 10/372,506

(22) Filed: Feb. 21, 2003

(30) Foreign Application Priority Data
Mar. 9, 2002 (DE) 102 10 441.7-24

(51) Int. Cl. B26D 5/00

(52) U.S. Cl. 83/821; 83/565

(57) ABSTRACT

A cutting tool holder with a cutting tool receiver, into which a cutting tool can be or is placed, wherein a slit clamping sleeve is placed on the cutting tool shank and is supported on the inner wall of the cutting tool receiver. Because at least a section of the slit in the clamping sleeve, which extends over at least a portion of the axial dimension, extends at a slant over at least a portion of the circumference of the clamping sleeve, the clamping sleeve has a limited axial freedom of movement and can absorb axially acting forces.

### BACKGROUND OF THE INVENTION

1. Field of the Invention

This invention relates to a cutting tool holder with a cutting tool receiver, into which a cutting tool can be or is placed, wherein a slit clamping sleeve is placed on the cutting tool shank and is supported on the inner wall of the cutting tool receiver.

2. Discussion of Related Art

The clamping sleeve of known cutting tool holders is used for the improved holding of the cutting tool in the cutting tool receiver. Not only does it compensate for tolerances, but it is also used to lock the cutting tool shank in the cutting tool receiver of the cutting tool holder.

Considerable axial forces occur during the operation of the cutting tool holder with the cutting tool, which for the greatest part are absorbed by the support of a collar of the cutting tool holder on the surface surrounding the cutting tool receiver of the cutting tool holder. However, over long term use of at least the cutting tool holder it is not possible to avoid more or less axially stressed forces acting on the clamping sleeve. This can lead to tilting and jamming of the cutting tool in the cutting tool receiver, which makes replacement of the cutting tool when it is used up substantially more difficult.

### SUMMARY OF THE INVENTION

It is one object of this invention to provide a cutting tool holder with a cutter of the type mentioned above but for which it is simply possible to absorb axial forces acting on the clamping sleeve, so that the jamming of the clamping sleeve in the cutting tool receiver is prevented.

In accordance with this invention, this object is attained because at least a section of the slit in the clamping sleeve, which extends over at least a portion of the axial dimension, extends at a slant over at least a portion of the circumference of the clamping sleeve.

By designing the slit with at least one section which is slanted with respect to the axial direction of the clamping sleeve, at least one clamping sleeve area with limited axial freedom is created in a simple manner, which can absorb the appearing axial forces acting on the clamping sleeve. During this the length, the slant and the width of the slit section have an important role and are used as parameters for the required compensating movements.

In a preferred embodiment of this invention, the slit extends curved or serpentine-like between both front ends of the clamping sleeve, wherein the start and end of the slit are offset from each other by a predetermined angle at the circumferences of the front ends. In this case the offset can be at an angle between 0° and 180° of the circumference of the clamping sleeve.

So that the slit interferes as little as possible with other functions of the clamping sleeve, in a further embodiment the width of the slit is between 10% and 20% of the axial dimension of the clamping sleeve.

The embodiment of the slit can also have two sections slanted with respect to each other, which preferably transition into each other in the center of the axial dimension of the clamping sleeve. In this case the transition of the two sections of the slit can be embodied as a curved intermediate section.

In another embodiment, the slit has an axially oriented start and end section, which are connected with each other by a spiral-shaped intermediate section, wherein the start and the end sections are axially oriented toward each other, and the intermediate section extends once over the circumference of the clamping sleeve.

The same effect on a clamping sleeve can be achieved by different guidance of the slit over the axial dimension of the clamping sleeve. However, care should be taken that partial areas of the clamping sleeve have a limited freedom of movement axially by partial areas of the slit.

Independently thereof, for fixing the clamping sleeve in the cutting tool receiver the area of a front end of the clamping sleeve has fastening receivers for fastening shoulders of the cutting tool shank and/or of the cutting tool receiver, which are preferably arranged in an even distribution over a circumferential line of the clamping sleeve.

### BRIEF DESCRIPTION OF THE DRAWINGS

This invention is explained in view of exemplary embodiments represented in the drawings, wherein:

FIG. 1 is a perspective plan view of a clamping sleeve with a slanted slit;

FIG. 2 is a lateral view of the clamping sleeve shown in FIG. 1;

FIG. 3 is a perspective plan view of a further embodiment of a clamping sleeve with two oppositely slanted slit sections;

FIG. 4 is a lateral view of the clamping sleeve shown in FIG. 3;

FIG. 5 is a perspective view of an embodiment similar to the clamping sleeve shown in FIG. 3 but with a curved transition between the slit sections;

FIG. 6 shows a lateral view of the clamping sleeve shown in FIG. 5;

FIG. 7 is a perspective plan view of a clamping sleeve with a helically-shaped slit; and

FIG. 8 is a lateral view of the clamping sleeve shown in FIG. 7.

### DESCRIPTION OF PREFERRED EMBODIMENTS

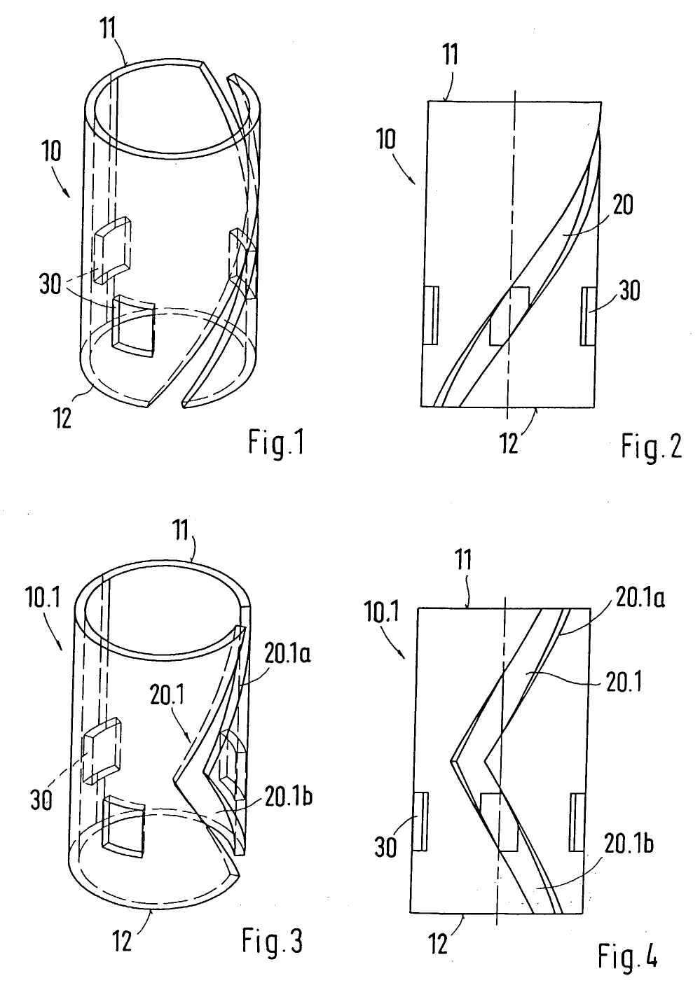

In the embodiment of a clamping sleeve 10 in accordance with FIGS. 1 and 2, a slit 20 extends from the upper front end to the lower front end. The width of the slit 20 is selected to be between 10% and 20% of the axial dimension of the clamping sleeve 10. For its other functions, seating in the cutting tool receiver and fastening to the cutting tool shank, the clamping sleeve 10 has fastening receivers 30 in a known manner, which in all embodiments are arranged in the area of the front end 12. With three fastening receivers 30, these are distributed, offset by 120°, about a circumferential line of the clamping sleeve. In this case the start and end of the slit 20 on the front ends 11 and 12 of the clamping sleeve 10 are offset on the circumference by approximately 150°. The continuous guidance in the axial direction of the clamping sleeve 10 can be serpentine-like, curved, or the like. It is only necessary that the start and end of the slit 20 are offset with respect to each other about the circumference, or that at least a partial area of the clamping sleeve 10 has a limited axial freedom of movement.

This requirement is met by a clamping sleeve 10.1 in accordance with FIGS. 3 and 4. The slit 10.1 has two sections 20.1a and 20.1b, which are slanted in opposite directions and transition into each other approximately in the center of the axial dimension. In that case the start and end of the slit 20.1 can be axially oriented toward each other at the front ends 11 and 12.

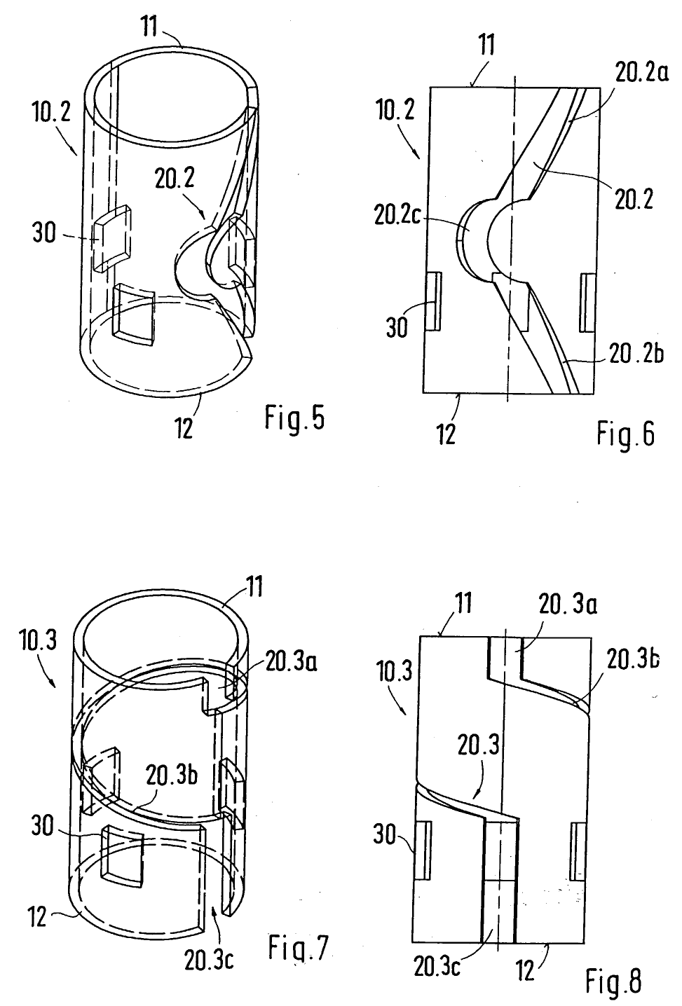

To avoid the sharp edge of the slit 20.1 at the transition of the sections 20.1a and 20.1b, a curved intermediate section 20.2c of the clamping sleeve 10.2 can connect the oppositely slanted two sections 20.2a and 20.2b with each other, as shown in the embodiment in FIGS. 5 and 6.

In the embodiment of the clamping sleeve 10.3 in accordance with FIGS. 7 and 8, start and end sections 20.3a and 20.3c, which are axially aligned with each other at the front ends 11 and 12, transition into a spiral or helically-shaped intermediate section 20.3b of the slit 20.3. The intermediate section 20.3b has at least one turn. In this case the end section 20.3c can extend as far as into the area of the fastening receivers 30.

For producing the clamping sleeves 10, 10.1, 10.2, 10.3, a strip of sheet metal is cut out of a sheet metal blank and is then rolled up. With the embodiments of FIGS. 1 and 2, the waste material formed during production of the sheet metal strip is minimized.

German Patent Reference 102 10 441.7-24, the priority document corresponding to this invention, and its teachings are incorporated, by reference, into this specification.

What is claimed is:

1. In a cutting tool holder having a cutting tool receiver into which a cutting tool is positionable, wherein a slit clamping sleeve is placed on a cutting tool shank and is supported on an inner wall of the cutting tool receiver, the improvement comprising:
at least one section (20.1a, 20.1b, 20.2a, 20.3b) of the slit (20, 20.1, 20.2, 20.3) in the clamping sleeve (10) extending over at least a portion of an axial dimension and extending at a slant over at least a portion of a circumference of the clamping sleeve (10).

2. In the cutting tool holder with the cutting tool receiver in accordance with claim 1, wherein the slit (20, 20.1, 20.2, 20.3) extends one of curved and serpentine between both front ends (11, 12) of the clamping sleeve (10), and a start and an end of the slit (20) are at an offset from each other by a predetermined angle at front end circumferences of the front ends (11, 12).

3. In the cutting tool holder with the cutting tool receiver in accordance with claim 2, wherein the offset is at an angle between 0° and 180° of the circumference of the clamping sleeve (10).

4. In the cutting tool holder with the cutting tool receiver in accordance with claim 3, wherein a width of the slit (20, 20.1, 20.2, 20.3) is between 10% and 20% of the axial dimension of the clamping sleeve (10).

5. In the cutting tool holder with the cutting tool receiver in accordance with claim 1, wherein the slit (20.1, 20.2) has two of the sections (20.1a and 20.1b, or 20.2a and 20.2b) slanted with respect to each other, which transition into each other in a center of the axial dimension of the clamping sleeve (10).

6. In the cutting tool holder with the cutting tool receiver in accordance with claim 5, wherein a transition of the two sections (20.2a and 20.2b) of the slit (20.2) forms a curved intermediate section (20.2c).

7. In the cutting tool holder with the cutting tool receiver in accordance with claim 1, wherein the slit (20.3) has an axially oriented start section and an end section (20.3a and 20.3c) connected with each other by a spiral-shaped intermediate section (20.3b).

8. In the cutting tool holder with the cutting tool receiver in accordance with claim 7, wherein the start section and the end section (20.3a and 20.3c) are axially oriented toward each other, and the intermediate section (20.3b) extends once over the circumference of the clamping sleeve (10).

9. In the cutting tool holder with the cutting tool receiver in accordance with claim 8, wherein near the front end (12) the clamping sleeve (10) has fastening receivers (30) for fastening shoulders of at least one of a cutting tool shank and the cutting tool receiver which are evenly distributed about the circumference of the clamping sleeve (10).

10. In the cutting tool holder with the cutting tool receiver in accordance with claim 1, wherein an offset of a start and an end of the slit (20) is at an angle between 0° and 180° of the circumference of the clamping sleeve (10).

11. In the cutting tool holder with the cutting tool receiver in accordance with claim 1, wherein a width of the slit (20, 20.1, 20.2, 20.3) is between 10% and 20% of the axial dimension of the clamping sleeve (10).

12. In the cutting tool holder with the cutting tool receiver in accordance with claim 11, wherein the slit (20.1, 20.2) has two of the sections (20.1a and 20.1b, or 20.2a and 20.2b) slanted with respect to each other, which transition into each other in a center of the axial dimension of the clamping sleeve (10).

13. In the cutting tool holder with the cutting tool receiver in accordance with claim 12, wherein a transition of the two sections (20.2a and 20.2b) of the slit (20.2) forms a curved intermediate section (20.2c).

14. In the cutting tool holder with the cutting tool receiver in accordance with claim 1, wherein the slit (20.3) has an axially oriented start section and an end section (20.3a and 20.3c) connected with each other by a spiral-shaped intermediate section (20.3b).

15. In the cutting tool holder with the cutting tool receiver in accordance with claim 14, wherein the start section and the end section (20.3a and 20.3c) are axially oriented toward each other, and the intermediate section (20.3b) extends once over the circumference of the clamping sleeve (10).

16. In the cutting tool holder with the cutting tool receiver in accordance with claim 1, wherein near a front end (12) the clamping sleeve (10) has fastening receivers (30) for fastening shoulders of at least one of a cutting tool shank and the cutting tool receiver which are evenly distributed about the circumference of the clamping sleeve (10).
